(19) United States
(12) Patent Application Publication
(10) Pub. No.: US 2023/0226757 A1
(43) Pub. Date: Jul. 20, 2023

(54) Method Of Manufacturing Three-Dimensional Shaped Object And Three-Dimensional Shaped Object

(71) Applicant: SEIKO EPSON CORPORATION, Tokyo (JP)

(72) Inventors: Yasutoshi HIDESHIMA, Matsumoto (JP); Hidefumi NAKAMURA, Hachinohe (JP)

(21) Appl. No.: 18/156,008

(22) Filed: Jan. 18, 2023

(30) Foreign Application Priority Data
Jan. 19, 2022 (JP) 2022-006171

(51) Int. Cl. B29C 64/165; B22F 10/28; B29C 64/209

(52) U.S. Cl. CPC B29C 64/165; B22F 10/28; B29C 64/209; B33Y 10/00

(57) ABSTRACT

A method of manufacturing a three-dimensional shaped object includes: a powder layer forming step of leveling a Fe-based metal powder to form a powder layer; a binder applying step of applying a binder solution to a formation region of the powder layer corresponding to a laminate-shaped body to be formed; an ink applying step of applying an ink containing carbon particles to the formation region such that an amount of the carbon particles supplied to the formation region is partially varied; a repeating step of, when the formation region to which the binder solution and the ink are applied is set as a unit layer, obtaining the laminate-shaped body in which a plurality of the unit layers are laminated; a sintering step of performing a sintering treatment on the laminate-shaped body to obtain a metal sintered body; and a quenching step of performing a quenching treatment to obtain a three-dimensional shaped object.

The present application is based on, and claims priority from JP Application Serial Number 2022-006171, filed Jan. 19, 2022, the disclosure of which is hereby incorporated by reference herein in its entirety.

### BACKGROUND

### 1. Technical Field

The present disclosure relates to a method of manufacturing a three-dimensional shaped object and a three-dimensional shaped object.

### 2. Related Art

In recent years, as a technique for shaping a three-dimensional object, a lamination shaping method using a metal powder has been widely used. This technique includes a step of calculating a cross-sectional shape of a three-dimensional object obtained by thinly slicing the three-dimensional object on a plane orthogonal to a laminating direction, a step of forming a powder layer by layering a metal powder, and a step of solidifying a part of the powder layer based on the shape obtained by the calculation. In this technique, the three-dimensional object is shaped by repeating the step of forming a powder layer and the step of solidifying a part of the powder layer.

For example, JP-A-2020-066139 discloses a method of manufacturing a three-dimensional shaped object in which a green body is obtained by repeating a layer forming step of forming a layer of a granulated powder and a binder applying step of applying a binder to the layer to form a shape, and then the obtained green body is sintered to obtain a sintered body.

The method described in JP-A-2020-066139 has the following problems. For example, when the metal powder having a high carbon content is used, toughness of the three-dimensional shaped object decreases. Therefore, durability of the three-dimensional shaped object is likely to decrease.

In addition, a method is known in which a three-dimensional shaped object is obtained using a metal powder having a low carbon content, and then a carburizing treatment is performed on a surface of the three-dimensional shaped object. In this method, the surface can be hardened in a state in which the carbon content in the three-dimensional shaped object is kept low. However, in this method, since it is necessary to add the carburizing treatment after manufacturing the three-dimensional shaped object, advantages of the lamination shaping method, such as simplicity and low cost, are impaired.

### SUMMARY

Therefore, an object of the present disclosure is to provide a method of manufacturing a three-dimensional shaped object having both high toughness and high surface hardness without impairing advantages of a lamination shaping method.

A method of manufacturing a three-dimensional shaped object according to an application example of the present disclosure includes: a powder layer forming step of leveling a Fe-based metal powder on a table to form a powder layer;

a binder applying step of applying a binder solution containing a binder to a formation region of the powder layer corresponding to a laminate-shaped body to be formed;

an ink applying step of applying an ink containing carbon particles to the formation region such that an amount of the carbon particles supplied to the formation region is partially varied;

a repeating step of repeating the powder layer forming step, the binder applying step, and the ink applying step one or more times, when the formation region to which the binder solution and the ink are applied is set as a unit layer, to obtain the laminate-shaped body in which a plurality of the unit layers are laminated;

a sintering step of performing a sintering treatment on the laminate-shaped body to obtain a metal sintered body; and

a quenching step of performing a quenching treatment on the metal sintered body to obtain a three-dimensional shaped object.

A method of manufacturing a three-dimensional shaped object according to an application example of the present disclosure includes:

a powder layer forming step of leveling a Fe-based metal powder on a table to form a powder layer;

an ink impregnating step of impregnating a formation region of the powder layer corresponding to a metal sintered body to be formed with an ink containing carbon particles such that an amount of the carbon particles to be supplied is partially varied, so as to obtain an ink impregnated layer;

an energy ray irradiating step of irradiating the formation region including at least the ink impregnated layer with an energy ray to obtain a sintered layer;

a repeating step of repeating the powder layer forming step, the ink impregnating step, and the energy ray irradiating step one or more times to obtain the metal sintered body in which a plurality of the sintered layers are laminated; and

a quenching step of performing a quenching treatment on the metal sintered body to obtain a three-dimensional shaped object.

A three-dimensional shaped object according to an application example of the present disclosure is made of a sintered material of a Fe-based metal powder and has a portion in which a carbon concentration decreases from an outer surface toward an inner portion.

### BRIEF DESCRIPTION OF THE DRAWINGS

FIG. 1 is a process diagram showing a method of manufacturing a three-dimensional shaped object according to a first embodiment.

FIG. 2 is a cross-sectional view showing the method of manufacturing the three-dimensional shaped object shown in FIG. 1.

FIG. 3 is a cross-sectional view showing the method of manufacturing the three-dimensional shaped object shown in FIG. 1.

FIG. 4 is a cross-sectional view showing the method of manufacturing the three-dimensional shaped object shown in FIG. 1.

FIG. 5 is a cross-sectional view showing the method of manufacturing the three-dimensional shaped object shown in FIG. 1.

FIG. 6 is a cross-sectional view showing the method of manufacturing the three-dimensional shaped object shown in FIG. 1.

FIG. 7 is a cross-sectional view showing the method of manufacturing the three-dimensional shaped object shown in FIG. 1.

FIG. 8 is a cross-sectional view showing the method of manufacturing the three-dimensional shaped object shown in FIG. 1.

FIG. 9 is a plan view showing the method of manufacturing the three-dimensional shaped object shown in FIG. 1.

FIG. 10 is a cross-sectional view showing the method of manufacturing the three-dimensional shaped object shown in FIG. 1.

FIG. 11 is a cross-sectional view showing the method of manufacturing the three-dimensional shaped object shown in FIG. 1.

FIG. 12 is a cross-sectional view showing the method of manufacturing the three-dimensional shaped object shown in FIG. 1.

FIG. 13 is a cross-sectional view showing the method of manufacturing the three-dimensional shaped object shown in FIG. 1.

FIG. 14 is a cross-sectional view showing the method of manufacturing the three-dimensional shaped object shown in FIG. 1.

FIG. 15 is a cross-sectional view showing the method of manufacturing the three-dimensional shaped object shown in FIG. 1.

FIG. 16 is a cross-sectional view showing the method of manufacturing the three-dimensional shaped object shown in FIG. 1.

FIG. 17 is a process diagram showing a method of manufacturing a three-dimensional shaped object according to a second embodiment.

FIG. 18 is a cross-sectional view showing the method of manufacturing the three-dimensional shaped object shown in FIG. 17.

FIG. 19 is a cross-sectional view showing the method of manufacturing the three-dimensional shaped object shown in FIG. 17.

FIG. 20 is a cross-sectional view showing the method of manufacturing the three-dimensional shaped object shown in FIG. 17.

FIG. 21 is a cross-sectional view showing the method of manufacturing the three-dimensional shaped object shown in FIG. 17.

FIG. 22 is a cross-sectional view schematically showing a distribution of a carbon concentration in a three-dimensional shaped object according to a third embodiment.

FIG. 23 is a top view schematically showing a distribution of a carbon concentration in a three-dimensional shaped object according to a modification.

### DESCRIPTION OF EXEMPLARY EMBODIMENTS

Hereinafter, preferred embodiments of a method of manufacturing a three-dimensional shaped object and a three-dimensional shaped object according to the present disclosure will be described in detail with reference to the accompanying drawings.

### 1. First Embodiment

First, a method of manufacturing a three-dimensional shaped object according to a first embodiment will be described.

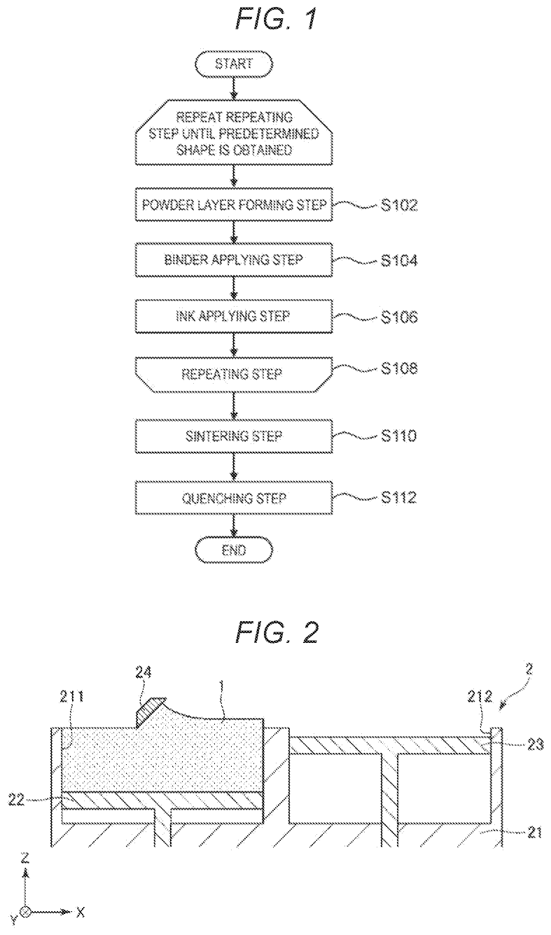

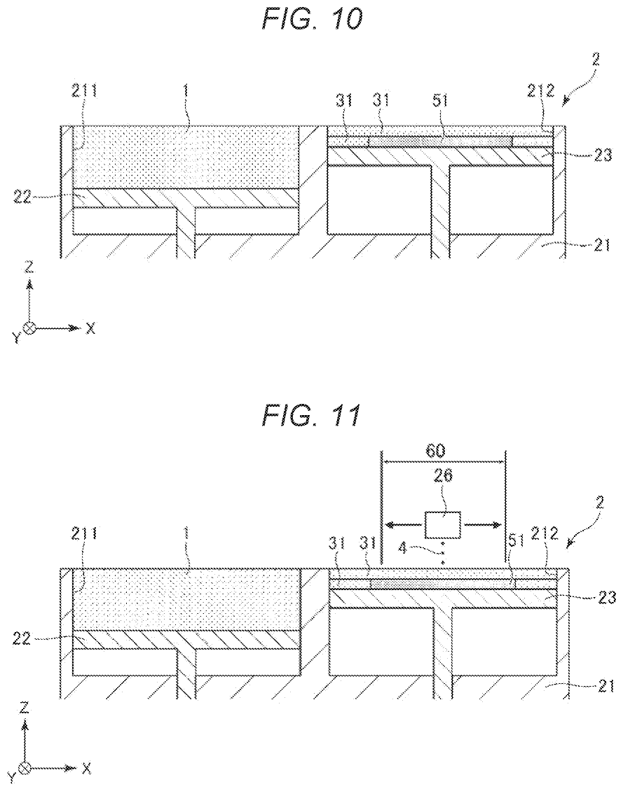

FIG. 1 is a process diagram showing the method of manufacturing the three-dimensional shaped object according to the first embodiment. FIGS. 2 to 8 are cross-sectional views showing the method of manufacturing the three-dimensional shaped object shown in FIG. 1. FIG. 9 is a plan view showing the method of manufacturing the three-dimensional shaped object shown in FIG. 1. FIGS. 10 to 16 are cross-sectional views showing the method of manufacturing the three-dimensional shaped object shown in FIG. 1. In the drawings of the present application, an X axis, a Y axis, and a Z axis are set as three axes orthogonal to each other. Each axis is represented by an arrow, and a tip end side is referred to as a “plus side” and a base end side is referred to as a “minus side”. In the following description, in particular, the plus side of the Z axis is referred to as “upper”, and the minus side of the Z axis is referred to as “lower”. In addition, both directions parallel to the X axis are referred to as an X axis direction, both directions parallel to the Y axis are referred to as a Y axis direction, and both directions parallel to the Z axis are referred to as a Z axis direction.

The method of manufacturing the three-dimensional shaped object according to the first embodiment is a method called a binder jet method, and includes a powder layer forming step S102, a binder applying step S104, an ink applying step S106, a repeating step S108, a sintering step S110, and a quenching step S112 as shown in FIG. 1.

In the powder layer forming step S102, a Fe-based metal powder 1 is leveled on a shaping stage 23 (on a table) to form a powder layer 31. In the binder applying step S104, a binder solution 4 is applied to a formation region 60 of the powder layer 31 corresponding to a laminate-shaped body 6 to be shaped. In the ink applying step S106, an ink 5 containing carbon particles is applied to the formation region 60 of the powder layer 31. In the repeating step S108, the powder layer forming step S102, the binder applying step S104, and the ink applying step S106 are repeated one or more times. Accordingly, when the formation region 60 to which the binder solution 4 and the ink 5 are applied is set as an ink applying layer 51 (unit layer), a plurality of the ink applying layers 51 are laminated to obtain the laminate-shaped body 6. In the sintering step S110, a sintering treatment is performed on the laminate-shaped body 6 to obtain a metal sintered body. In the quenching step S112, a quenching treatment is performed on the metal sintered body to obtain a three-dimensional shaped object 10. Hereinafter, each step will be sequentially described.

### 1.1. Lamination Shaping Device

First, a lamination shaping device 2 will be described as an example of a device used in the method of manufacturing the three-dimensional shaped object according to the first embodiment.

The lamination shaping device 2 includes a device main body 21 including a powder storage unit 211 and a shaping unit 212, a powder supply elevator 22 provided in the powder storage unit 211, a shaping stage 23 provided in the shaping unit 212, and a coater 24, a roller 25, and a liquid supply unit 26 provided movably on the device main body 21.

The powder storage unit 211 is a recessed portion provided in the device main body 21 and having an open upper portion. The Fe-based metal powder 1 is stored in the powder storage unit 211. An appropriate amount of the Fe-based metal powder 1 stored in the powder storage unit 211 is supplied to the shaping unit 212 by the coater 24.

The powder supply elevator 22 is disposed at a bottom portion of the powder storage unit 211. The powder supply elevator 22 is movable in the Z axis direction in a state where the Fe-based metal powder 1 is placed on the powder supply elevator 22. By moving the powder supply elevator 22 upward, the Fe-based metal powder 1 placed on the powder supply elevator 22 is pushed up and protrudes from the powder storage unit 211. Accordingly, the protruded Fe-based metal powder 1 can be moved to the shaping unit 212 side by the coater 24.

The shaping unit 212 is a recessed portion provided in the device main body 21 and having an open upper portion. The shaping stage 23 is disposed inside the shaping unit 212. On the shaping stage 23, the Fe-based metal powder 1 is leveled by the coater 24 and laid in layers. In addition, the shaping stage 23 is movable in the Z axis direction in a state where the Fe-based metal powder 1 is laid on the shaping stage 23. By appropriately setting a height of the shaping stage 23, an amount of the Fe-based metal powder 1 laid on the shaping stage 23 can be adjusted.

The coater 24 and the roller 25 are movable in the X axis direction from the powder storage unit 211 to the shaping unit 212. The coater 24 can level and lay the Fe-based metal powder 1 in layers by pulling the Fe-based metal powder 1. The roller 25 compresses the leveled Fe-based metal powder 1 from above.

The liquid supply unit 26 is implemented by, for example, an inkjet head or a dispenser, and is movable in the X axis direction and the Y axis direction in the shaping unit 212. The liquid supply unit 26 can supply a target amount of the binder solution 4 or the ink 5 to a target position. The liquid supply unit 26 may include a plurality of dispense nozzles in one head. The binder solution 4 may be dispensed from one dispense nozzle, and the ink 5 may be dispensed from another dispense nozzle. In addition, a head for supplying the binder solution 4 and a head for supplying the ink 5 may be separate members.

### 1.2. Powder Layer Forming Step

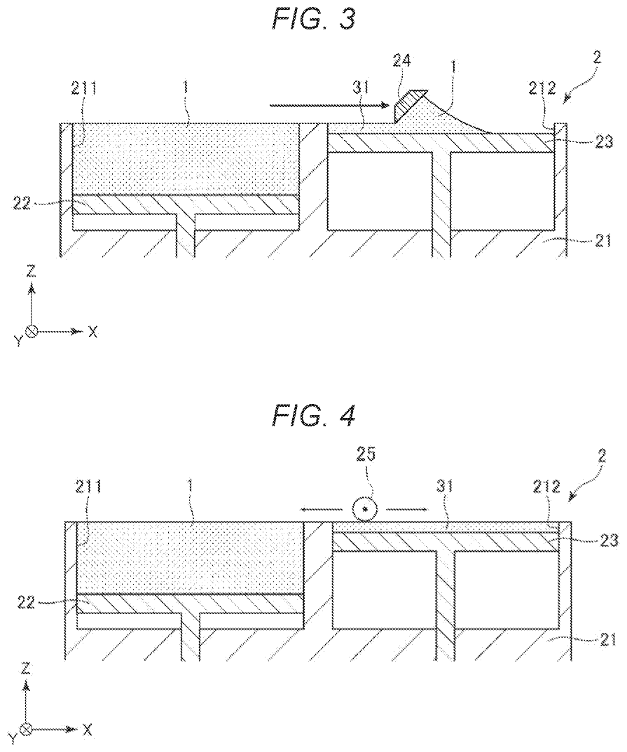

In the powder layer forming step S102, the Fe-based metal powder 1 is laid on the shaping stage 23 to form the powder layer 31. Specifically, as shown in FIGS. 2 and 3, the Fe-based metal powder 1 stored in the powder storage unit 211 is pulled onto the shaping stage 23 by using the coater 24, and the Fe-based metal powder 1 is leveled to a uniform thickness. Accordingly, the powder layer 31 shown in FIG. 4 is obtained. At this time, a thickness of the powder layer 31 can be adjusted by lowering an upper surface of the shaping stage 23 below an upper end of the shaping unit 212 and adjusting an amount by which the upper surface of the shaping stage 23 is lowered.

Next, the roller 25 is moved in the X axis direction while the powder layer 31 is compressed in a thickness direction by the roller 25. Accordingly, a filling rate of the Fe-based metal powder 1 in the powder layer 31 can be increased. The compression by the roller 25 may be performed as necessary, and may be omitted. In addition, the powder layer 31 may be compressed by a unit different from the roller 25, for example, a pressing plate.

A constituent material of the Fe-based metal powder 1 is not particularly limited as long as the constituent material is a metal material containing Fe as a main component. An example of the constituent material is a Fe-based metal material in which improvement in hardness is expected by adding carbon particles and performing a quenching treatment. The Fe-based metal material is not particularly limited, and examples thereof include stainless steel, steel for mechanical structure, tool steel, high-speed steel, die steel, bearing steel, and alloy steel.

In addition, if necessary, the surface of the Fe-based metal powder 1 may be subjected to any surface treatment such as a silane coupling agent treatment.

In addition, a method of manufacturing the Fe-based metal powder 1 is not particularly limited, and examples thereof include various atomization methods such as a water atomization method and a gas atomization method, and a pulverization method. Among these, a powder manufactured by the water atomization method often has an oxide film on particle surfaces. The oxide film reacts with the carbon particles and is reduced in a sintering treatment or the like to be described later. Therefore, when the Fe-based metal powder 1 having an oxide film is used, an amount of the carbon particles contained in the ink 5 described later or an amount of the ink 5 supplied to the formation region 60 may be adjusted in consideration of the consumption of the carbon particles due to the reduction.

### 1.3. Binder Applying Step

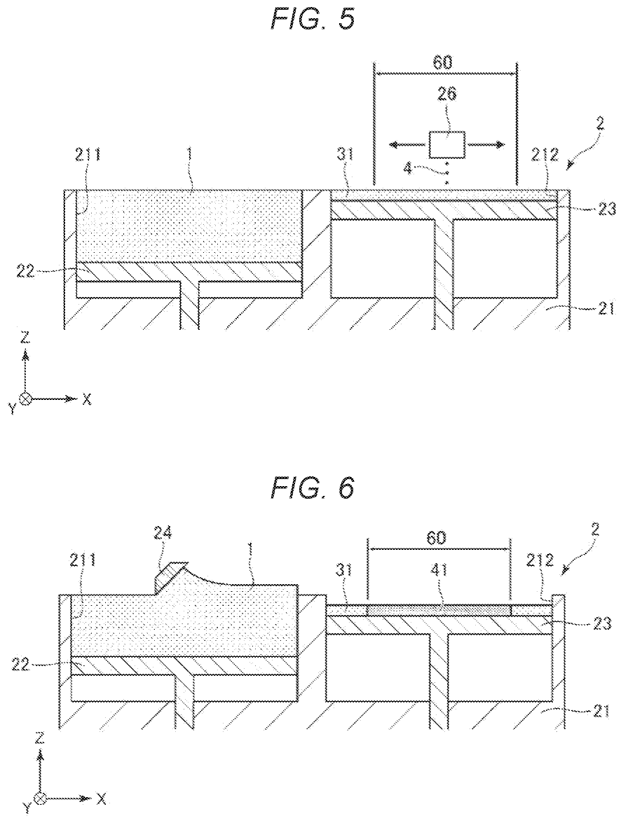

In the binder applying step S104, as shown in FIG. 5, the liquid supply unit 26 supplies the binder solution 4 to the formation region 60 of the powder layer 31 corresponding to the laminate-shaped body 6 to be shaped. The binder solution 4 is a liquid containing a binder and a solvent or a dispersion medium. In the formation region 60 to which the binder solution 4 is supplied, the particles of the Fe-based metal powder 1 are bound to each other, and a binding layer 41 shown in FIG. 6 is obtained. In the binding layer 41, the particles of the Fe-based metal powder 1 are bound to each other by the binder, and the Fe-based metal powder 1 has a shape retention property that is not broken due to its own weight.

The binding layer 41 may be heated simultaneously with or after the supply of the binder solution 4. Accordingly, volatilization of the solvent or the dispersion medium contained in the binder solution 4 is promoted, and binding of the particles due to solidification or curing of the binder is promoted. When the binder contains a photocurable resin or an ultraviolet curable resin, light irradiation or ultraviolet irradiation may be performed instead of or in combination with heating.

A heating temperature during heating is not particularly limited, and is preferably 50° C. or higher and 250° C. or lower, and more preferably 70° C. or higher and 200° C. or lower. Accordingly, when the Fe-based metal powder 1 not bound by the binder solution 4 is reused, it is possible to prevent the Fe-based metal powder 1 from being denatured due to heating.

The binder solution 4 is not particularly limited as long as the binder solution 4 is a liquid having a component capable of binding the particles of the Fe-based metal powder 1 to each other. Examples of the solvent or dispersion medium contained in the binder solution 4 include water, alcohols, ketones, and carboxylic acid esters, and the solvent or dispersion medium may be a mixed liquid containing at least one of the above. In addition, examples of the binder contained in the binder solution 4 include fatty acids, paraffin wax, microwax, polyethylene, polypropylene, polystyrene, acrylic resins, polyamide resins, polyesters, stearic acid, polyvinylpyrrolidone (PVP), polyvinyl alcohol (PVA), and polyethylene glycol (PEG).

### 1.4. Ink Applying Step

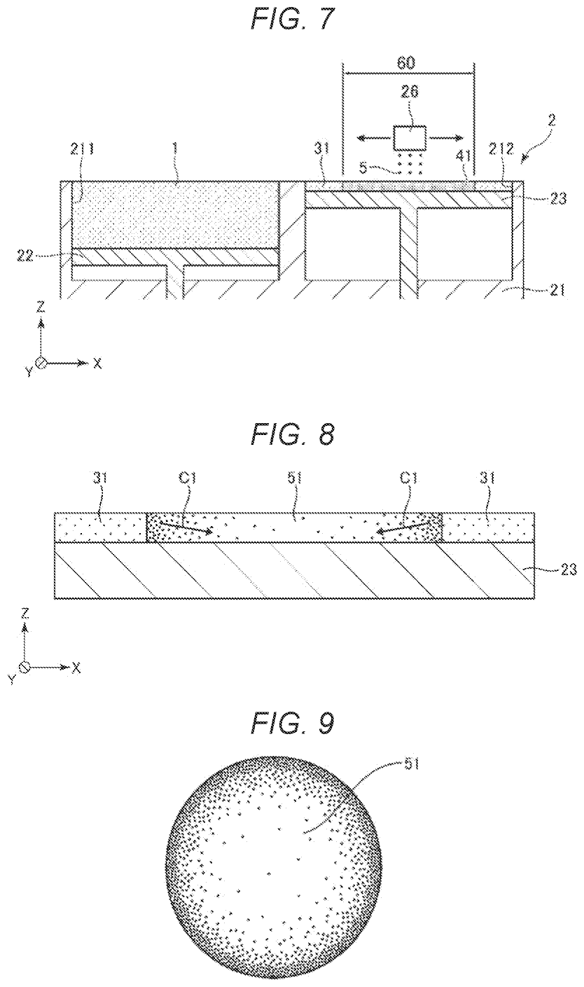

In the ink applying step S106, the ink 5 is supplied to the formation region 60 of the powder layer 31. The ink 5 is a liquid containing carbon particles and a dispersion medium. In the present embodiment, the ink 5 is supplied to the binding layer 41 shown in FIG. 7 corresponding to the formation region 60. Accordingly, the binding layer 41 can be impregnated with the ink 5. As a result, carbon particles are applied to the binding layer 41, and the ink applying layer 51 (unit layer) shown in FIG. 8 is obtained. At this time, an amount of carbon particles supplied to the binding layer 41 is partially varied. The amount of the carbon particles depends on hardness of a quenched structure in the quenching treatment described later. The quenched structure due to martensitic transformation exhibits high hardness and properties such as wear resistance. On the other hand, the quenched structure may cause a decrease in toughness. Therefore, by forming a quenched structure in which hardness is partially adjusted only in a necessary portion, it is possible to finally obtain the three-dimensional shaped object 10 having both high toughness and high hardness.

In the present embodiment, as shown in FIG. 8, a gradient is formed in which the amount of the carbon particles decreases from an outer edge portion of the ink applying layer 51 toward an inner portion (a portion other than the outer edge portion). FIG. 8 is a partially enlarged view of the ink applying layer 51 shown in FIG. 7. In FIG. 8, the gradient of the amount of the carbon particles, in other words, a gradient of a concentration of the carbon particles is represented by an inclination of an arrow C1. In the example of FIG. 8, the arrow C1 is inclined such that the inner portion of the ink applying layer 51 is lower than the outer edge portion of the ink applying layer 51. By providing such a gradient of the concentration, finally, the three-dimensional shaped object 10 having high surface hardness and high internal toughness is obtained. The gradient of the concentration may be a smooth gradient (a gradient in which the inclination continuously changes) or a stepwise gradient (a gradient in which the inclination discontinuously changes). It is sufficient that the gradient is macroscopically provided as a whole, and in consideration of decarburization during sintering, a portion having a high concentration may be present in the vicinity of the surface. In addition, in this step, the amount of carbon particles to be supplied may be partially varied, and thus a pattern of the gradient is not particularly limited. For example, a part of the formation region 60 may include a region to which the ink 5 is not supplied at all (a region in which the amount of carbon particles to be supplied is zero).

FIG. 9 is a plan view of the ink applying layer 51 shown in FIG. 8. In FIG. 9, the gradient of the concentration of the carbon particles is represented by a density of dots. In the example of FIG. 9, an outer edge of the ink applying layer 51 has a circular shape, and the concentration of the carbon particles increases radially from the center toward the outer edge. A pattern of the gradient of the concentration is not limited to the shown pattern. For example, in a part of the outer edge, the gradient of the concentration may be partially steeper or gentler than in the other parts. In addition, the binder applying step S104 and the ink applying step S106 may be performed in a reverse order. That is, after the ink 5 is applied to the formation region 60, the binder solution 4 may be applied, and the obtained layer may be used as the ink applying layer 5 (unit layer).

The carbon particles are particles composed of a material containing a simple substance carbon as a main component, and examples of the carbon particles include graphite particles, carbon black, carbon fibers, and carbon nanotubes. The term “main component” refers to a component that accounts for 50.0% by mass or more. The carbon particles are preferably particles in which 90.0% by mass or more of the component is the simple substance carbon.

The carbon particles are particularly preferably carbon black. The carbon black is an industrially manufactured carbon powder, and has uniform surface properties such as the presence of various functional groups on the particle surfaces. Therefore, the ink 5 containing the carbon black as the carbon powder is excellent in stability, and can be supplied such that the carbon particles are uniformly distributed.

An average particle diameter of the carbon particles is preferably 1/100000 or more and 1/100 or less, more preferably 1/50000 or more and 1/500 or less, and still more preferably 1/10000 or more and 1/1000 or less of an average particle diameter of the Fe-based metal powder 1. Accordingly, it is easier for the carbon particles to penetrate gaps between the particles of the Fe-based metal powder 1. Therefore, when the ink 5 is supplied to the formation region 60, the carbon particles are easily distributed along the surfaces of the particles of the Fe-based metal powder 1. As a result, the quenching treatment to be described later can be performed more uniformly.

The average particle diameter of the carbon particles is preferably 10 nm or more and 10 μm or less, and more preferably 10 nm or more and 5 μm or less. The average particle diameter of the carbon particles refers to a particle diameter when a cumulative mass based on volume is 50% using a laser diffraction particle size distribution analyzer. In addition, in the ink 5, the carbon particles may be aggregated to form secondary particles. In this case, a particle diameter of the secondary particles is set as the particle diameter of the carbon particles.

Examples of the dispersion medium include water, an organic solvent, and a mixture of water and an organic solvent. Among these, examples of water include ion exchange water, ultrafiltrated water, reverse osmosis water, distilled water, pure water, and ultrapure water. Examples of the organic solvent include a water-soluble solvent and a water-insoluble solvent.

A content of the carbon particles in the ink 5 is appropriately set depending on a supply method of the ink 5, and is preferably 0.1% by mass or more and 50.0% by mass or less, more preferably 1.0% by mass or more and 30.0% by mass or less, still more preferably 2.0% by mass or more and 20.0% by mass or less, and particularly preferably 5.0% by mass or more and 20.0% by mass or less. By setting the content of the carbon particles in the ink 5 within the above range, both the ease of handling of the ink 5 and a supply efficiency of the carbon particles can be achieved. When the content of the carbon particles in the ink 5 is less than the lower limit value, the supply efficiency decreases, and a large amount of the ink 5 needs to be supplied to the formation region 60, and thus a mechanical strength of the ink applying layer 51 may decrease. When the content of the carbon particles in the ink 5 exceeds the upper limit value, a viscosity of the ink 5 is too high, and thus, depending on the supply method, handleability of the ink 5 may decrease.

Additives other than the above components may be added to the ink 5. Examples of the additive include a dispersant, a surfactant, a wetting agent (anti-drying agent), an antioxidant, an ultraviolet absorber, a penetration accelerator, a preservative, an antifungal agent, a pH adjuster, a viscosity adjuster, and a chelating agent.

### 1.5. Repeating Step

In the repeating step S108, when the formation region 60 to which the binder solution 4 and the ink 5 are applied is set as the ink applying layer 51 (unit layer), the powder layer forming step S102, the binder applying step S104, and the ink applying step S106 are repeated one or more times until a laminated body formed by laminating the plurality of ink applying layers 51 has a predetermined shape. That is, these steps are performed twice or more in total. Accordingly, the three-dimensional laminate-shaped body 6 shown in FIG. 15 is obtained.

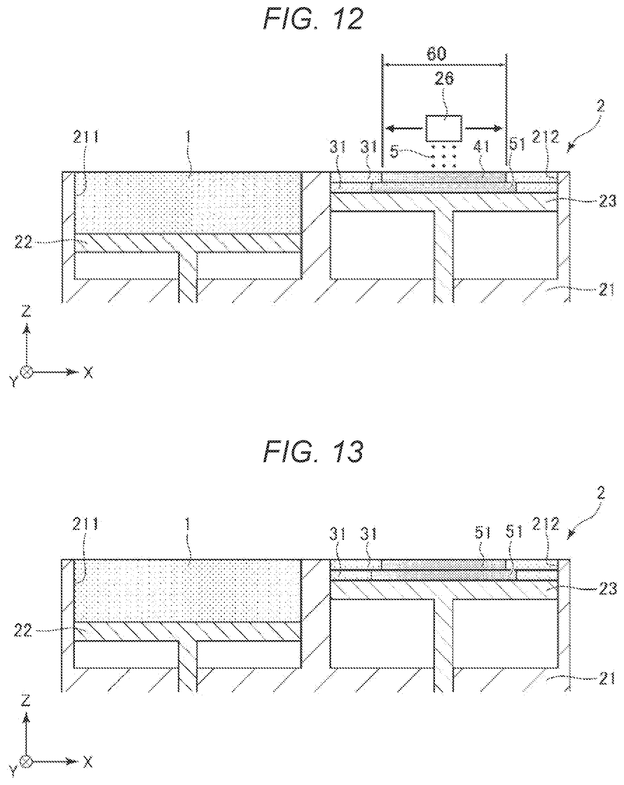

Specifically, first, as shown in FIG. 10, a new powder layer 31 is formed at the ink applying layer 51 shown in FIG. 8. Next, as shown in FIG. 11, the binder solution 4 is supplied to the formation region 60 of the powder layer 31. Accordingly, the binding layer 41 shown in FIG. 12 is obtained.

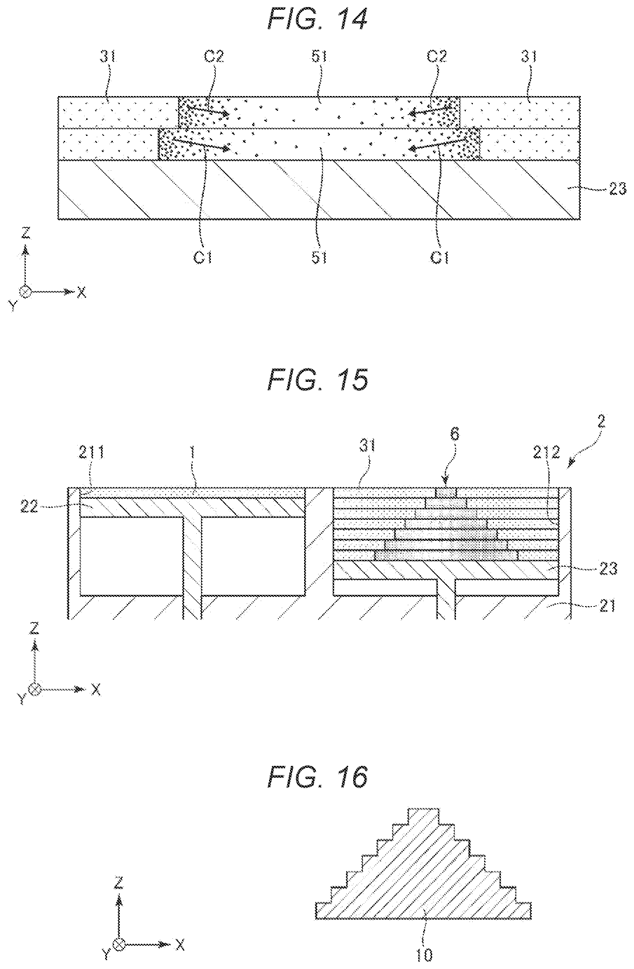

Next, the ink 5 is supplied to the formation region 60 of the powder layer 31. In the present embodiment, the ink 5 is supplied to the binding layer 41 shown in FIG. 12. Accordingly, the ink applying layer 51 shown in FIG. 13 is obtained. FIG. 14 is a partially enlarged view of the ink applying layer 51 shown in FIG. 13. In FIG. 14, the gradient of the concentration of the carbon particles is represented by an inclination of an arrow C2. In the example of FIG. 14, the arrow C2 is also inclined such that the inner portion of the ink applying layer 51 is lower than the outer edge portion of the ink applying layer 51.

The inclination of the arrow C2 shown in FIG. 14 may be the same as the inclination of the arrow C1 shown in FIG. 8, and is preferably different from the inclination of the arrow C1. Accordingly, the gradient of the concentration of the carbon particles can be optimized according to a shape of the three-dimensional shaped object 10.

As described above, the laminate-shaped body 6 shown in FIG. 15 is a laminated body of the plurality of ink applying layers 51 (unit layers). In the powder layer 31, the Fe-based metal powder 1 that does not constitute the ink applying layer 51 is recovered and reused as necessary. In addition, when the repeating step S108 is repeated twice or more, the application of the ink 5 may be omitted in some of the repeating steps S108. Further, when the repeating step S108 is repeated twice or more, in some of the repeating steps S108, the amount of the carbon particles supplied to the formation region 60 may not be partially varied.

### 1.6. Sintering Step

In the sintering step S110, the sintering treatment is performed on the laminate-shaped body 6. In the sintering treatment, the laminate-shaped body 6 is heated to cause a sintering reaction. Accordingly, the metal sintered body is obtained.

A sintering temperature varies depending on a type, a particle diameter, or the like of the Fe-based metal powder 1. As an example, the sintering temperature is preferably 980° C. or higher and 1330° C. or lower, and more preferably 1050° C. or higher and 1260° C. or lower. In addition, a sintering time is preferably 0.2 hours or longer and 7 hours or shorter, and more preferably 1 hour or longer and 6 hours or shorter.

Examples of an atmosphere in the sintering treatment include a reducing atmosphere such as hydrogen, an inert atmosphere such as nitrogen and argon, and a reduced-pressure atmosphere obtained by reducing these atmospheres. A pressure in the reduced-pressure atmosphere is not particularly limited as long as the pressure is less than normal pressure (100 kPa). The pressure is preferably 10 kPa or less, and more preferably 1 kPa or less.

### 1.7. Quenching Step

In the quenching step S112, the quenching treatment is performed on the metal sintered body. The quenching treatment is a treatment of heating the metal sintered body and then rapidly cooling the metal sintered body. Accordingly, in a region where the carbon concentration is increased to a predetermined concentration, a metal structure is transformed from austenite to martensite, and accordingly becomes a quenched structure derived from martensite, and has high hardness. Changing into such a quenched structure is referred to as “quenching”. On the other hand, in a region where the carbon concentration is not increased, since the quenched structure is not formed, the hardness is not increased. By such a quenching treatment, the three-dimensional shaped object 10 shown in FIG. 16 is obtained.

A quenching temperature is, for example, 950° C. or higher and 1200° C. or lower. In addition, a quenching time is, for example, 0.2 hours or longer and 3 hours or shorter. For the rapid cooling, water cooling, oil cooling, or the like is used.

After the quenching treatment, a tempering treatment may be performed as necessary. The tempering treatment is a treatment in which the metal sintered body after the quenching treatment is heated again at a temperature lower than that of the quenching treatment. Accordingly, the toughness can be applied to the metal sintered body while the hardness of the metal sintered body is slightly reduced.

A tempering temperature is, for example, 100° C. or higher and 250° C. or lower. In addition, a tempering time is, for example, 0.3 hours or longer and 5 hours or shorter.

### 1.8. Effects of First Embodiment

As described above, the method of manufacturing the three-dimensional shaped object according to the first embodiment includes the powder layer forming step S102, the binder applying step S104, the ink applying step S106, the repeating step S108, the sintering step S110, and the quenching step S112. In the powder layer forming step S102, the Fe-based metal powder 1 is leveled on the shaping stage 23 (on the table) to form the powder layer 31. In the binder applying step S104, the binder solution 4 containing the binder is applied to the formation region 60 of the powder layer 31 corresponding to the laminate-shaped body 6 to be formed. In the ink applying step S106, the ink 5 containing the carbon particles is applied to the formation region 60 such that the amount of the carbon particles supplied to the formation region 60 is partially varied. In the repeating step S108, when the formation region 60 to which the binder solution 4 and the ink 5 are applied is set as the ink applying layer 51 (unit layer) , the powder layer forming step S102, the binder applying step S104, and the ink applying step S106 are repeated one or more times to obtain the laminate-shaped body 6 in which the plurality of ink applying layers 51 are laminated. In the sintering step S110, the sintering treatment is performed on the laminate-shaped body 6 to obtain the metal sintered body. In the quenching step S112, the quenching treatment is performed on the metal sintered body to obtain the three-dimensional shaped object 10.

According to such a configuration, by partially varying the amount of the carbon particles supplied to the formation region 60, it is possible to partially vary the degree of quenching in the finally obtained three-dimensional shaped object 10, that is, the hardness of the quenched structure. Accordingly, for example, in the vicinity of the surface of the three-dimensional shaped object 10, the degree of quenching can be increased to increase the hardness. On the other hand, inside the three-dimensional shaped object 10, the degree of quenching can be decreased to prevent an increase in the hardness. As a result, it is possible to implement the three-dimensional shaped object 10 having high surface hardness and high internal toughness. In such a three-dimensional shaped object 10, both the high toughness and the high hardness are achieved, and thus, for example, both wear resistance and durability are achieved.

In addition, according to the above-described method, it is possible to enjoy advantages of the binder jet method, which is a lamination shaping method, without impairing the advantages of the binder jet method. Therefore, for example, a region having a cavity therein can be set as the formation region 60. Accordingly, a hollow structure can be easily formed, a weight of the formation region 60 can be reduced, and finally, the three-dimensional shaped object 10 having high surface hardness and a light weight can be obtained.

In addition, in the method of manufacturing the three-dimensional shaped object according to the first embodiment, the ink 5 is applied such that the amount of the carbon particles supplied to the outer edge portion of the formation region 60 is larger than the amount of the carbon particles supplied to a portion other than the outer edge portion of the formation region 60.

By shaping the laminate-shaped body 6 using the formation region 60 obtained in this manner and finally obtaining the three-dimensional shaped object 10, it is possible to efficiently manufacture the three-dimensional shaped object 10 having high surface hardness and high internal toughness.

In addition, by providing a gradient in which the concentration of the carbon particles continuously changes, it is possible to prevent occurrence of cracking or the like due to a difference in thermal expansion between a quenched structure layer in the vicinity of the surface and the internal metal structure in the three-dimensional shaped object 10. Accordingly, reliability of the three-dimensional shaped object 10 can be improved.

In addition, in the repeating step S108, when the ink applying layers 51 (unit layers) are laminated, the amount of the carbon particles may be varied between the ink applying layers 51. For example, in FIG. 14, the inclination of the arrow C1 representing the gradient of the concentration of the carbon particles in the first ink applying layer 51 is different from the inclination of the arrow C2 representing the gradient of the concentration of the carbon particles in the second ink applying layer 51. This variation corresponds to a variation of the amount of the carbon particles between the ink applying layers 51.

According to such a configuration, the amount of the carbon particles to be supplied can be optimized according to the shape of the three-dimensional shaped object 10. Accordingly, a thickness of a layer having high hardness can be optimized according to the shape of the three-dimensional shaped object 10, and a balance between the high hardness and the high toughness of the three-dimensional shaped object 10 can be optimized.

When the ink 5 is applied, the amount of the carbon particles to be supplied is adjusted such that the carbon concentration in the three-dimensional shaped object 10 is preferably 0.2% by mass or more, and more preferably 0.3% by mass or more and 2.2% by mass or less.

According to such a configuration, it is possible to more reliably cause quenching by the quenching treatment. The carbon concentration immediately after being supplied by the ink 5 may decrease due to the subsequent steps. Therefore, the amount of the carbon particles to be supplied by the ink 5 is preferably set in consideration of the decrease in the concentration.

In addition, as shown in FIGS. 7 and 12, it is preferable that the ink applying step S106 includes, when the ink 5 is dispensed as liquid droplets from a plurality of aligned nozzles, an operation of partially varying the amount of the carbon particles by changing a density of the liquid droplets dispensed in a unit area.

When the ink 5 is dispensed from the plurality of nozzles included in the liquid supply unit 26, control of selecting a nozzle from which the ink 5 is to be dispensed is easy and accurate, and therefore, according to the above operation, the amount of the carbon particles to be supplied to the unit area can be easily and accurately controlled. Accordingly, finally, it is possible to easily manufacture the three-dimensional shaped object 10 having a target carbon concentration at a target position.

In the binder applying step S104 and the ink applying step S106, the application of the binder solution 4 and the application of the ink 5 may be performed substantially simultaneously. That is, the binder solution 4 and the ink 5 may be dispensed substantially simultaneously from the same head or different heads. Accordingly, throughput of the binder applying step S104 and the ink applying step S106 can be increased. The term “substantially simultaneously” means that a time difference is 1 second or shorter.

On the other hand, in consideration of mixing of the dispensed binder solution 4 and ink 5, it is preferable to provide a time difference between the application of the binder solution 4 and the application of the ink 5.

Alternatively, the binder solution 4 and the ink 5 may be mixed to form a mixed liquid, and the mixed liquid may be dispensed. That is, the binder applying step S104 and the ink applying step S106 may be simultaneously performed by applying a liquid containing both the binder and the carbon particles to the formation region 60. Accordingly, the throughput of the binder applying step S104 and the ink applying step S106 can be increased.

In addition, the sintering treatment and the quenching treatment may be performed by different processing devices, or may be performed by one processing device. That is, after the completion of the sintering treatment, by keeping the laminate-shaped body 6 in the processing device, the sintering treatment and the quenching treatment may be continuously performed without lowering a temperature of the laminate-shaped body 6 to room temperature (25° C.)

According to such a configuration, since the sintering step S110 and the quenching step S112 can be continuously performed, the throughput of these steps can be increased.

In addition, the powder layer forming step S102 may include an operation of compressing the powder layer 31 in the thickness direction. By this operation, the filling rate of the Fe-based metal powder 1 in the powder layer 31 can be increased. Accordingly, when the Fe-based metal powder 1 having a high bulk density is used, the density of the three-dimensional shaped object 10 can be finally increased.

### 2. Second Embodiment

Next, a method of manufacturing a three-dimensional shaped object according to a second embodiment will be described.

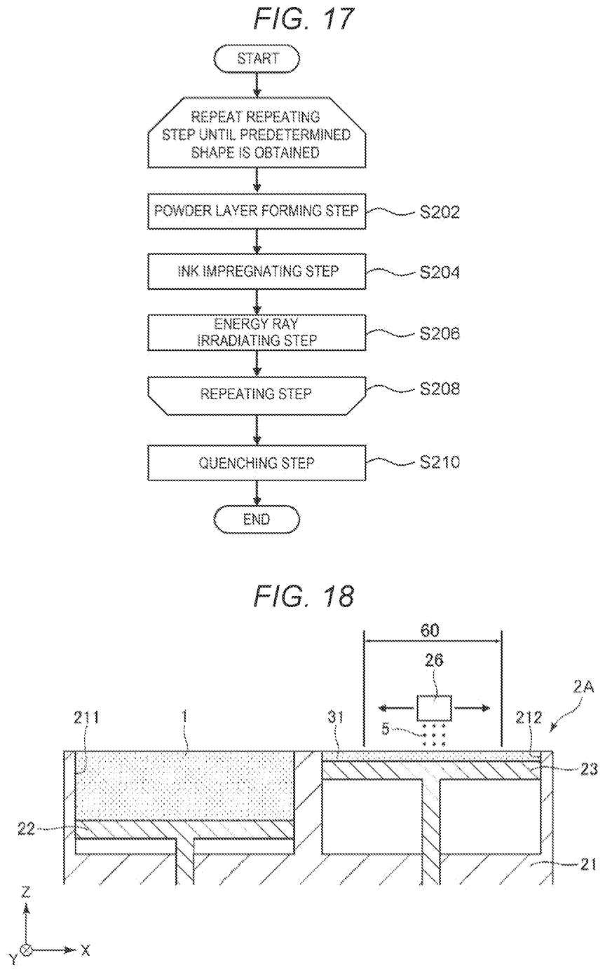

FIG. 17 is a process diagram showing the method of manufacturing the three-dimensional shaped object according to the second embodiment. FIGS. 18 to 21 are cross-sectional views showing the method of manufacturing the three-dimensional shaped object shown in FIG. 17.

Hereinafter, the second embodiment will be described, and in the following description, differences from the first embodiment will be mainly described, and description of similar matters will be omitted. In the drawings, the same components as those of the first embodiment are denoted by the same reference numerals.

The method of manufacturing the three-dimensional shaped object according to the second embodiment is a method called a selective laser sintering (SLS) method, and includes a powder layer forming step S202, an ink impregnating step S204, an energy ray irradiating step S206, a repeating step S208, and a quenching step S210 as shown in FIG. 17.

### 2.1. Lamination Shaping Device

First, a lamination shaping device 2A will be described as an example of a device used in the method of manufacturing the three-dimensional shaped object according to the second embodiment.

The lamination shaping device 2A is the same as the lamination shaping device 2 described above except that an energy ray irradiating unit 27 is added.

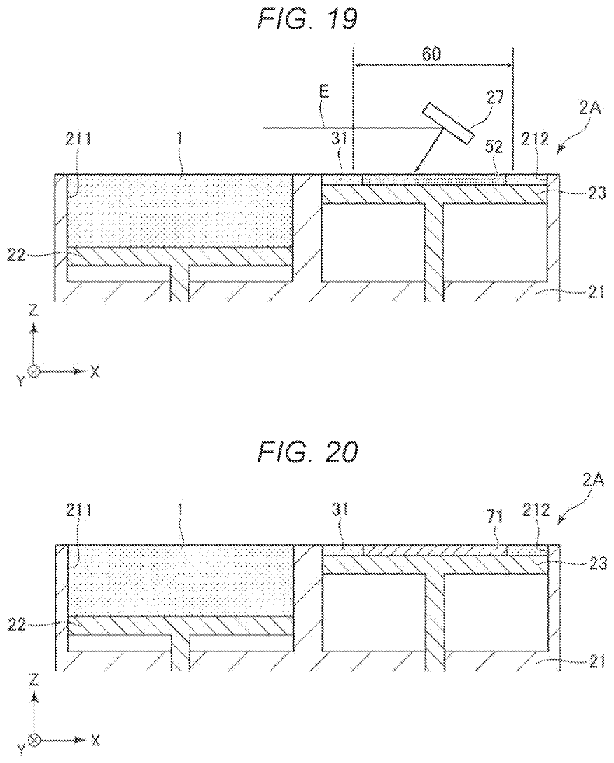

As shown in FIG. 19, the energy ray irradiating unit 27 can irradiate any position on the shaping stage 23 with an energy ray E. Examples of the energy ray E include a laser beam and an electron beam. By the irradiation with the energy ray E, it is possible to cause a sintering reaction between the particles of the Fe-based metal powder 1.

### 2.2. Powder Layer Forming Step

In the powder layer forming step S202, similar to the powder layer forming step S102 of the first embodiment, the Fe-based metal powder 1 is leveled on the shaping stage 23 (on the table) to form the powder layer 31.

### 2.3. Ink Impregnating Step

In the ink impregnating step S204, the ink 5 is supplied to the formation region 60 of the powder layer 31 corresponding to a metal sintered body 7 to be formed. Accordingly, the formation region 60 can be impregnated with the ink 5. As a result, an ink impregnated layer 52 shown in FIG. 19 is obtained. At this time, the amount of the carbon particles supplied to the formation region 60 is partially varied. Specifically, similar to the gradient of the concentration indicated by the arrow C1 in FIG. 8, a gradient of a concentration of the carbon particles is provided such that a concentration in an inner portion of the ink impregnated layer 52 is lower than a concentration in an outer edge of the ink impregnated layer 52. Accordingly, finally, the three-dimensional shaped object 10 having high surface hardness and high internal toughness is obtained. A part of the formation region 60 may include a region to which the ink 5 is not supplied at all (a region in which the amount of carbon particles to be supplied is zero).

The average particle diameter of the carbon particles is preferably 1/100000 or more and 1/100 or less, more preferably 1/50000 or more and 1/500 or less, and still more preferably 1/10000 or more and 1/1000 or less of the average particle diameter of the Fe-based metal powder 1. Accordingly, it is easier for the carbon particles to penetrate into gaps between the particles of the Fe-based metal powder 1. Therefore, when the ink 5 is supplied to the formation region 60, the carbon particles are easily distributed along the surfaces of the particles of the Fe-based metal powder 1. As a result, the quenching treatment to be described later can be performed more uniformly.

### 2.4. Energy Ray Irradiating Step

In the energy ray irradiating step S206, as shown in FIG. 19, the energy ray irradiating unit 27 irradiates the formation region 60 including at least the ink impregnated layer 52 with the energy ray E. In the ink impregnated layer 52 irradiated with the energy ray E, the particles of the Fe-based metal powder 1 are sintered to obtain a sintered layer 71 shown in FIG. 20. In the sintered layer 71, the particles of the Fe-based metal powder 1 are sintered to form a metal sintered body.

### 2.5. Repeating Step

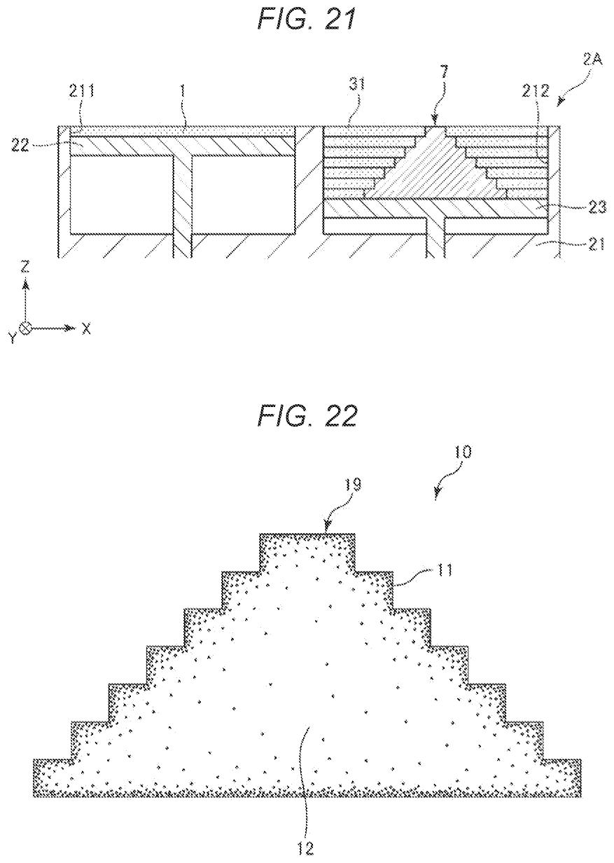

In the repeating step S208, the powder layer forming step S202, the ink impregnating step S204, and the energy ray irradiating step S206 are repeated one or more times until a laminated body formed by laminating a plurality of the sintered layers 71 has a predetermined shape. Accordingly, the three-dimensional metal sintered body 7 shown in FIG. 21 is obtained.

### 2.6. Quenching Step

In the quenching step S210, similar to the quenching step S112 of the first embodiment, a quenching treatment is performed on the metal sintered body 7. Accordingly, the three-dimensional shaped object 10 shown in FIG. 16 is obtained. In the second embodiment, since energy supplied by the energy ray E is high, the quenching treatment may be completed at the same time with the completion of the energy ray irradiating step S206. In this case, this step may be omitted, or this step may be performed and then a re-quenching treatment may be performed. In addition, similar to the first embodiment, a tempering treatment may be performed after the quenching treatment.

### 2.7. Effects of Second Embodiment

As described above, the method of manufacturing the three-dimensional shaped object according to the second embodiment includes the powder layer forming step S202, the ink impregnating step S204, the energy ray irradiating step S206, the repeating step S208, and the quenching step S210. In the powder layer forming step S202, the Fe-based metal powder 1 is leveled on the shaping stage 23 (on the table) to form the powder layer 31. In the ink impregnating step S204, the formation region 60 of the powder layer 31 corresponding to the metal sintered body 7 to be formed is impregnated with the ink 5 containing carbon particles such that the amount of the carbon particles to be supplied is partially varied, so as to obtain the ink impregnated layer 52. In the energy ray irradiating step S206, the formation region 60 including at least the ink impregnated layer 52 is irradiated with the energy ray E to obtain the sintered layer 71. In the repeating step S208, the powder layer forming step S202, the ink impregnating step S204, and the energy ray irradiating step S206 are repeated one or more times to obtain the metal sintered body 7 in which the plurality of sintered layers 71 are laminated. In the quenching step S210, the quenching treatment is performed on the metal sintered body 7 to obtain the three-dimensional shaped object 10.

According to such a configuration, by partially varying the amount of the carbon particles supplied to the formation region 60, it is possible to partially vary the degree of quenching in the finally obtained three-dimensional shaped object 10, that is, the hardness of the quenched structure. Accordingly, for example, in the vicinity of the surface of the three-dimensional shaped object 10, the degree of quenching can be increased to increase the hardness. On the other hand, inside the three-dimensional shaped object 10, the degree of quenching can be decreased to prevent an increase in the hardness. As a result, it is possible to implement the three-dimensional shaped object 10 having high surface hardness and high internal toughness. In such a three-dimensional shaped object 10, both the high toughness and the high hardness are achieved, and thus, for example, both wear resistance and durability are achieved.

In addition, according to the above-described method, it is possible to enjoy the advantage of the selective laser sintering method, which is a lamination shaping method, without impairing the advantage of the selective laser sintering method. Therefore, for example, a region having a cavity therein can be set as the formation region 60. Accordingly, a weight of the formation region 60 can be reduced, and finally, the three-dimensional shaped object 10 having high surface hardness and a light weight can be obtained.

In addition, in the method of manufacturing the three-dimensional shaped object according to the second embodiment, the ink 5 is applied such that the amount of the carbon particles supplied to the outer edge portion of the formation region 60 is larger than the amount of the carbon particles supplied to a portion other than the outer edge portion of the formation region 60.

By shaping the metal sintered body 7 using the formation region 60 obtained in this manner and finally obtaining the three-dimensional shaped object 10, it is possible to efficiently manufacture the three-dimensional shaped object 10 having high surface hardness and high internal toughness.

In addition, by providing a gradient in which the concentration of the carbon particles continuously changes, it is possible to prevent occurrence of cracking or the like due to a difference in thermal expansion between a quenched structure layer in the vicinity of the surface and the internal metal structure in the three-dimensional shaped object 10. Accordingly, reliability of the three-dimensional shaped object 10 can be improved.

### 3. Third Embodiment

Next, a three-dimensional shaped object according to a third embodiment will be described.

FIG. 22 is a cross-sectional view schematically showing a distribution of a carbon concentration in the three-dimensional shaped object 10 according to the third embodiment.

Hereinafter, the third embodiment will be described, and in the following description, differences from the first embodiment will be mainly described, and description of similar matters will be omitted.

In the three-dimensional shaped object 10 shown in FIG. 22, the carbon concentration is represented by a density of dots. The three-dimensional shaped object 10 is made of a sintered material of the Fe-based metal powder 1. The three-dimensional shaped object 10 has a portion 19 in which the carbon concentration decreases from an outer surface 11 toward an inner portion 12. In the present embodiment, the entirety of the three-dimensional shaped object 10 is formed by the portion 19. Only a part of the three-dimensional shaped object 10 may be formed by the portion 19, and the other portions may be formed by other structures. Examples of the other structure include a structure having a constant carbon concentration.

As described above, the three-dimensional shaped object 10 according to the present embodiment is made of the sintered material of the Fe-based metal powder 1, and has the portion 19 in which the carbon concentration decreases from the outer surface 11 toward the inner portion 12.

According to such a configuration, it is possible to achieve both high hardness of the outer surface 11 and high toughness of the inner portion 12.

In addition, in the portion 19, as described above, it is preferable that the strength of the gradient in which the carbon concentration decreases is partially varied.

According to such a configuration, for example, when the portion 19 includes a locally thinned portion and a portion thicker than the locally thinned portion, it is possible to achieve both the high hardness of the outer surface 11 and the high toughness of the inner portion 12. That is, if the gradient of the carbon concentration is gentle in the thinned portion, a range of the outer surface 11 is too thick, a volume of the inner portion 12 is relatively small, and it is difficult to achieve both the high hardness and the high toughness. Therefore, in such a portion, it is easy to achieve both the high hardness and the high toughness by increasing the gradient of the carbon concentration.

The carbon concentration in the outer surface 11 is preferably 0.2% by mass or more, and more preferably 0.3% by mass or more and 2.2% by mass or less. When the carbon concentration is within the above range, a metal structure of the outer surface 11 can be satisfactorily quenched. Accordingly, it is possible to more reliably increase the hardness of the outer surface 11.

The carbon concentration in the outer surface 11 is measured by, for example, an electron probe microanalyzer (EPMA) method.

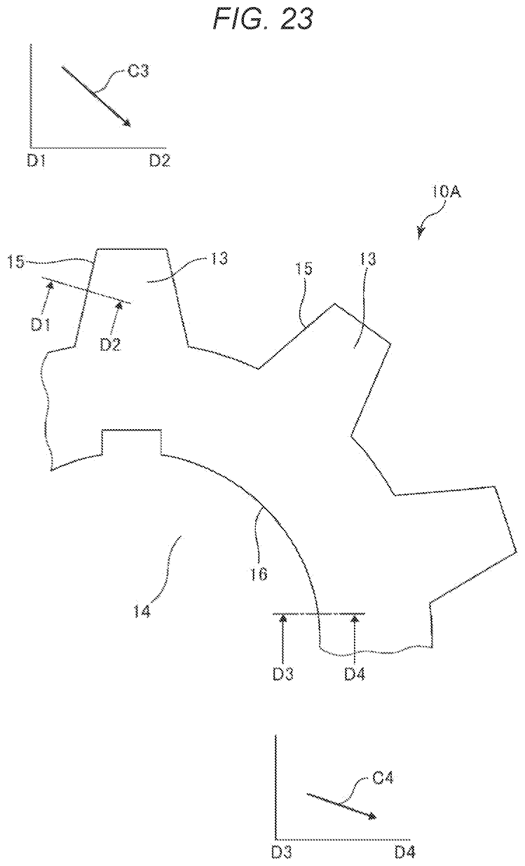

FIG. 23 is a top view schematically showing a distribution of a carbon concentration in a three-dimensional shaped object 10A according to a modification.

The three-dimensional shaped object 10A shown in FIG. 23 is a spur gear having a plurality of external teeth 13 and a shaft hole 14. Each of the external teeth 13 has a tooth surface 15. The external teeth 13 mesh with external teeth of other gears (not shown) to transmit rotation. Therefore, the tooth surface 15 rubs against teeth surfaces of other gears, thereby causing wear. Therefore, the three-dimensional shaped object 10A is configured such that a carbon concentration decreases from the tooth surface 15 toward an inner portion thereof. In FIG. 23, a gradient of the carbon concentration in the tooth surface 15 is represented by an inclination of an arrow C3.

The carbon concentration also decreases from an inner surface 16 of the shaft hole 14 toward the inner portion. A gradient of the carbon concentration in the inner surface 16 of the shaft hole 14 is represented by an inclination of an arrow C4. A shaft (not shown) is inserted into the shaft hole 14. Therefore, a friction between a surface of the shaft hole 14 and the shaft is small.

Therefore, the inclination of the arrow C3 is preferably steeper than the inclination of the arrow C4. Accordingly, the tooth surface 15 can have hardness higher than that of the inner surface 16. On the other hand, the inner surface 16 can have toughness higher than that of the tooth surface 15. Therefore, according to the three-dimensional shaped object 10A of the modification, it is possible to obtain a gear that is excellent in wear resistance of the tooth surface 15 and durability of the shaft hole 14 and that has a long life.

When the three-dimensional shaped object 10A is manufactured as described above, the ink 5 may be applied such that the strength of the gradient in which the amount of the carbon particles decreases from the outer edge portion toward the inner portion of the formation region 60 shown in FIG. 8 is partially varied. That is, the inclination of the arrow C3 representing the gradient of the carbon concentration in the tooth surface 15 may be different from the inclination of the arrow C4 representing the gradient of the carbon concentration in the inner surface 16. As shown in FIG. 23, the arrow C3 represents a gradient of the carbon concentration in a cross section that crosses the tooth surface 15 and couples a point D1 and a point D2. The arrow C4 represents a gradient of the carbon concentration in a cross section that crosses the inner surface 16 and couples a point D3 and a point D4.

According to such a configuration, when the manufactured three-dimensional shaped object 10A is applied to the gear, the hardness of the tooth surface 15 can be increased, and the toughness of the inner surface 16 of the shaft hole 14 can be increased at the same time. As a result, it is possible to easily obtain a gear having a long life.

The three-dimensional shaped objects 10 and 10A as described above can be used as all or a part of, for example, transportation equipment parts such as automobile parts, bicycle parts, railroad vehicle parts, ship parts, aircraft parts, and space transportation parts, electronic device parts such as personal computer parts, mobile phone terminal parts, tablet terminal parts, and wearable terminal parts, parts for electrical equipment such as refrigerators, washing machines, and air conditioners, machine parts such as machine tools and semiconductor manufacturing equipment, parts for plants such as nuclear power plants, thermal power plants, hydropower plants, refineries, and chemical complexes, watch parts, metal tableware, and ornaments such as jewelry and eyeglass frames.

The method of manufacturing the three-dimensional shaped object and the three-dimensional shaped object according to the present disclosure have been described above based on the illustrated embodiments, but the present disclosure is not limited thereto. For example, the three-dimensional shaped object according to the present disclosure may be an object in which any component is added to the above-described embodiments.

In addition, the method of manufacturing the three-dimensional shaped object according to the present disclosure may be a method in which any desired step is added to the above-described embodiments.

What is claimed is:

1. A method of manufacturing a three-dimensional shaped object, the method comprising:
a powder layer forming step of leveling a Fe-based metal powder on a table to form a powder layer;
a binder applying step of applying a binder solution containing a binder to a formation region of the powder layer corresponding to a laminate-shaped body to be formed;
an ink applying step of applying an ink containing carbon particles to the formation region such that an amount of the carbon particles supplied to the formation region is partially varied;
a repeating step of repeating the powder layer forming step, the binder applying step, and the ink applying step one or more times, when the formation region to which the binder solution and the ink are applied is set as a unit layer, to obtain the laminate-shaped body in which a plurality of the unit layers are laminated;
a sintering step of performing a sintering treatment on the laminate-shaped body to obtain a metal sintered body; and
a quenching step of performing a quenching treatment on the metal sintered body to obtain a three-dimensional shaped object.

2. The method of manufacturing a three-dimensional shaped object according to claim 1, wherein
the ink is applied such that an amount of the carbon particles supplied to an outer edge portion of the formation region is larger than an amount of the carbon particles supplied to a portion other than the outer edge portion of the formation region.

3. The method of manufacturing a three-dimensional shaped object according to claim 2, wherein
the ink is applied such that a strength of a gradient in which the amount of the carbon particles decreases from the outer edge portion toward an inner portion of the formation region is partially varied.

4. The method of manufacturing a three-dimensional shaped object according to claim 1, wherein
in the repeating step, when the unit layers are laminated, the amount of the carbon particles is varied between the formation regions.

5. The method of manufacturing a three-dimensional shaped object according to claim 1, wherein
the amount of the carbon particles to be supplied is adjusted by applying the ink such that a carbon concentration in the three-dimensional shaped object is 0.2% by mass or more.

6. The method of manufacturing a three-dimensional shaped object according to claim 1, wherein
an average particle diameter of the carbon particles is 1/100000 or more and 1/100 or less of an average particle diameter of the Fe-based metal powder.

7. The method of manufacturing a three-dimensional shaped object according to claim 1, wherein
the ink applying step includes, when the ink is dispensed as a liquid droplet from a plurality of aligned nozzles, an operation of partially varying the amount of the carbon particles by changing a density of the liquid droplet dispensed in a unit area.

8. The method of manufacturing a three-dimensional shaped object according to claim 1, wherein
the binder applying step and the ink applying step are simultaneously performed by applying a liquid containing both the binder and the carbon particles to the formation region.

9. The method of manufacturing a three-dimensional shaped object according to claim 1, wherein
the sintering step and the quenching step are continuously performed by continuously performing the sintering treatment and the quenching treatment without lowering a temperature of the laminate-shaped body to room temperature.

10. A method of manufacturing a three-dimensional shaped object, the method comprising:
a powder layer forming step of leveling a Fe-based metal powder on a table to form a powder layer;
an ink impregnating step of impregnating a formation region of the powder layer corresponding to a metal sintered body to be formed with an ink containing carbon particles such that an amount of the carbon particles to be supplied is partially varied, so as to obtain an ink impregnated layer;
an energy ray irradiating step of irradiating the formation region including at least the ink impregnated layer with an energy ray to obtain a sintered layer;
a repeating step of repeating the powder layer forming step, the ink impregnating step, and the energy ray irradiating step one or more times to obtain the metal sintered body in which a plurality of the sintered layers are laminated; and
a quenching step of performing a quenching treatment on the metal sintered body to obtain a three-dimensional shaped object.

11. The method of manufacturing a three-dimensional shaped object according to claim 10, wherein
the ink is applied such that an amount of the carbon particles supplied to an outer edge portion of the formation region is larger than an amount of the carbon particles supplied to a portion other than the outer edge portion of the formation region.

12. The method of manufacturing a three-dimensional shaped object according to claim 10, wherein
an average particle diameter of the carbon particles is 1/100000 or more and 1/100 or less of an average particle diameter of the Fe-based metal powder.

13. The method of manufacturing a three-dimensional shaped object according to claim 1, further comprising:
an operation of compressing the powder layer in a thickness direction.

14. A three-dimensional shaped object made of a sintered material of a Fe-based metal powder and having a portion in which a carbon concentration decreases from an outer surface toward an inner portion.

15. The three-dimensional shaped object according to claim 14, wherein
a strength of a gradient in which the carbon concentration decreases is partially varied.

16. The three-dimensional shaped object according to claim 14, wherein
the carbon concentration in the outer surface is 0.2% by mass or more.
